(19) United States
(12) Patent Application Publication
(10) Pub. No.: US 2019/0293041 A1
(43) Pub. Date: Sep. 26, 2019

(54) ELECTRIC TOOL FOR FACILITATING STARTING OF ENGINE

(71) Applicant: TTI (MACAO COMMERCIAL OFFSHORE) LIMITED, Macau (MO)

(72) Inventors: Li Teng DONG, Dongguan (CN); Chin Hung LAM, Tsuen Wan, NT (CN); Long Jiang LV, Dongguan (CN); Tian HUO, Dongguan (CN)

(21) Appl. No.: 15/776,204

(22) PCT Filed: Nov. 30, 2015
(86) PCT No.: PCT/CN2015/095999

§ 371 Date: May 15, 2018

(51) Int. Cl. F02N 11/12; F02N 15/02; F02N 11/08; B25F 5/00

(52) U.S. Cl. CPC F02N 11/12; F02N 15/02; F02N 2250/04; F02N 11/087; B25F 5/001; F02N 15/027

(57) ABSTRACT

A system and method of an electric tool (100) for facilitating starting of an engine, comprising a tool bit (102) having a bit portion (102A) arranged to engage with a rotatable component of a starter module of the engine, and a transmission mechanism (112) arranged to transfer a rotational movement provided by a motor (104) housed within a casing (110) of the electric tool to the bit portion, wherein the motor is arranged to be powered by a power source connected thereto, and wherein the rotational movement provided by the motor is transferred to the rotatable component of the starter module via the transmission mechanism only if the bit portion is engaged with the rotatable component.

### TECHNICAL FIELD

The present invention relates to an electric tool for facilitating starting of an engine, and particularly, although not exclusively, to an electric driver for use in starting a gasoline engine.

### BACKGROUND

Engines such as gasoline engines, petrol engines or combustion engines may be started with engine starters. A conventional engine starter may adopt human-powered techniques such as a removable crank handle which engaged the front of the crankshaft, pulling on an airplane propeller, or pulling a cord that was wound around an open-face pulley.

Such hand-crank string method is inconvenient, difficult, and dangerous as the behaviour of an engine during starting is not always predictable. For example, the engine can kick back, causing sudden reverse rotation. In addition, it is not easy to start an engine successfully as a large amount of force and effect is generally required in manually starting an engine.

### SUMMARY OF THE INVENTION

In accordance with a first aspect of the present invention, there is provided an electric tool for facilitating starting of an engine, comprising a tool bit having a bit portion arranged to engage with a rotatable component of a starter module of the engine, and a transmission mechanism arranged to transfer a rotational movement provided by a motor housed within a casing of the electric tool to the bit portion, wherein the motor is arranged to be powered by a power source connected thereto, and wherein the rotational movement provided by the motor is transferred to the rotatable component of the starter module via the transmission mechanism only if the bit portion is engaged with the rotatable component.

In an embodiment of the first aspect, wherein the bit portion is provided at an end of the tool bit having an engagement portion arranged to be removably engaged with the transmission mechanism.

In an embodiment of the first aspect, wherein the transmission mechanism further comprises a chuck having a receiving portion arranged to receive at least a portion of the engagement portion of the tool bit.

In an embodiment of the first aspect, wherein a dimension of an exterior of the engagement portion of the tool bit substantially matches with a dimension of an interior of the receiving portion of the chuck.

In an embodiment of the first aspect, wherein a second bit portion is provided at a second end of the tool bit, wherein the second end is opposite to the end provided with the bit portion.

In an embodiment of the first aspect, wherein the bit portion and the second bit portion include shapes and/or dimensions different from each other.

In an embodiment of the first aspect, wherein the second bit portion is arranged to engage with a rotatable component of a second starter module different from the starter module of the engine.

In an embodiment of the first aspect, wherein the rotatable component of the starter module is further arranged to prevent an engagement with the second bit portion.

In an embodiment of the first aspect, wherein the tool bit further comprises a one-way engagement mechanism arranged to transfer a rotational movement on an outer ring of the tool bit to the bit portion of the tool bit.

In an embodiment of the first aspect, wherein the bit portion is formed at an end of a central shaft arranged to selectively engage with the one-way engagement mechanism.

In an embodiment of the first aspect, wherein the one-way engagement mechanism is further arranged to transfer the rotational movement on the outer ring in a first rotational direction provided by the motor via the transmission mechanism to the bit portion and the rotatable component engaged with the bit portion.

In an embodiment of the first aspect, wherein the one-way engagement mechanism is further arranged to prevent the rotational movement on the outer ring in a second rotational direction opposite to the first rotational direction provided by the motor via the transmission mechanism from being transferred to the bit portion and the rotatable component engaged with the bit portion.

In an embodiment of the first aspect, wherein the one-way engagement mechanism is further arranged to prevent a rotational movement provided by the rotatable component of the starter module of the engine from being transferred to the motor via the transmission mechanism and the tool bit.

In an embodiment of the first aspect, wherein the one-way engagement mechanism is a one-way bearing.

In an embodiment of the first aspect, wherein the engagement portion is defined on the outer ring.

In an embodiment of the first aspect, wherein the outer ring includes a substantially hexagonal shape of cross-section being perpendicular to a main axis of the tool bit at an exterior of the engagement portion.

In an embodiment of the first aspect, the electric tool further comprises a direction switching mechanism arranged to select a direction of the rotational movement provided by the motor.

In an embodiment of the first aspect, wherein the direction switching mechanism includes a detection mechanism arranged to detect an engagement of the tool bit to the transmission mechanism.

In an embodiment of the first aspect, whereupon the detection mechanism detects the engagement of the tool bit to the transmission mechanism, the direction switching mechanism selects the direction of the rotational movement provided by the motor in accordance with a predetermined direction.

In an embodiment of the first aspect, wherein the direction switching mechanism comprises an actuator arranged to select the direction of the rotational movement provided by the motor.

In an embodiment of the first aspect, wherein the actuator is arranged to be manipulated by a user of the electric tool.

In an embodiment of the first aspect, wherein the transmission mechanism further comprises a resilient member, wherein the chuck is arranged to engage with a transmission or an output shaft of the motor via the resilient member.

In an embodiment of the first aspect, wherein the resilient member is arranged to absorb an impact induced on a driven component and/or the motor during an operation of the electric tool, wherein the driven component includes at least one of the transmission, the chuck, the tool bit and the rotatable component.

In an embodiment of the first aspect, wherein the resilient member includes a material of rubber.

In an embodiment of the first aspect, the electric tool further comprises a locking structure on the casing arranged to cooperate with a corresponding locking structure provided on the starter module when the bit portion is engaged with the rotatable component of the starter module, wherein the cooperation of the locking structure on the casing and the corresponding locking structure on the starter module is arranged to prevent a relative rotational movement of the casing with respect to the starter module.

In an embodiment of the first aspect, the electric tool further comprises an interlock structure arrange to enable an activation of the motor when the locking structure on the casing and the corresponding locking structure are securely engaged

In an embodiment of the first aspect, wherein the interlock structure comprises an interlock actuator arranged to be actuated by the starter module.

In an embodiment of the first aspect, wherein the interlock structure is proximate to the locking structure on the casing.

In an embodiment of the first aspect, wherein the interlock structure is arranged to allow an electric switch housed in the casing being actuated by a press-button provided on the casing.

In an embodiment of the first aspect, wherein the engine is a gasoline engine.

In accordance with a first aspect of the present invention, there is provided a tool bit for use in a power tool, comprising a central shaft arranged to selectively engage with an outer ring, such that the outer ring is arranged to allow the central shaft to rotate in a first direction along a common axis of the central shaft and the outer ring with respect to the outer ring, and is further arranged to prevent the central shaft to rotate in a second direction opposite to the first direction along a common axis of the central shaft and the outer ring with respect to the outer ring.

In an embodiment of the second aspect, the tool bit further comprises a one-way engagement mechanism arranged to selectively engage the central shaft to the outer ring.

In an embodiment of the second aspect, wherein the one-way engagement mechanism is a one-way bearing.

In an embodiment of the second aspect, wherein the one-way bearing is fixed to the outer ring.

In an embodiment of the second aspect, wherein the central shaft is provided with a bit portion at least one end of the central shaft.

In an embodiment of the second aspect, wherein the bit portion includes dimensions and/or shapes different from another bit portion provided at another end of the central shaft.

In an embodiment of the second aspect, wherein the outer ring is further arranged to receive rotational movement provided by a motor of the power tool.

In an embodiment of the second aspect, wherein the power tool is arranged to facilitate starting of an engine.

In an embodiment of the second aspect, wherein the power tool is an electric driver.

In an embodiment of the second aspect, wherein the power tool is an electric drill.

### BRIEF DESCRIPTION OF THE DRAWINGS

Embodiments of the present invention will now be described, by way of example, with reference to the accompanying drawings in which:

FIG. 1 is a perspective view of an electric tool in accordance with one embodiment of the present invention;

FIG. 2 is a perspective view of the electric tool of FIG. 1 with the battery and the tool bit removed from the main body;

FIG. 3 is a perspective view of the electric tool of FIG. 1 with the tool bit reversely mounted in the chuck of the main body;

FIG. 4A is an illustration of an internal connection of a motor and a power source in which the motor is configured to generate a rotational movement in a first direction;

FIG. 4B is an illustration of an internal connection of a motor and a power source in which the motor is configured to generate a rotational movement in a second direction opposite to the first direction;

FIG. 5 is a perspective view of the electric tool of FIG. 1 with part of the casing removed showing the internal components of the electric tool;

FIG. 6 is a cross sectional view of the electric tool of FIG. 5 showing the internal components of the electric tool;

FIG. 7 is an explosion view of the transmission mechanism and the tool bit of the electric tool of FIG. 1;

FIG. 8 is a perspective view of a portion of the transmission mechanism of the electric tool of FIG. 1;

FIG. 9 is a perspective view of a tool bit of the electric tool of FIG. 1;

FIG. 10 is a perspective view of the tool bit of FIG. 9 at an opposite angle;

FIG. 11 is an explosion view of the tool bit of FIG. 9;

FIG. 12A is a perspective view of tool bit and the chuck, wherein the tool bit is removed from the chuck;

FIG. 12B is an explosion view of the tool bit and the chuck of FIG. 12A;

FIG. 13A is a perspective view of tool bit and the chuck with a different engagement mechanism, wherein the tool bit is removed from the chuck;

FIG. 13B is an explosion view of the tool bit and the chuck of FIG. 13A; and

FIG. 14 is a cross section view of a portion of the electric tool in accordance with one embodiment of the present invention.

### DETAILED DESCRIPTION OF THE PREFERRED EMBODIMENT

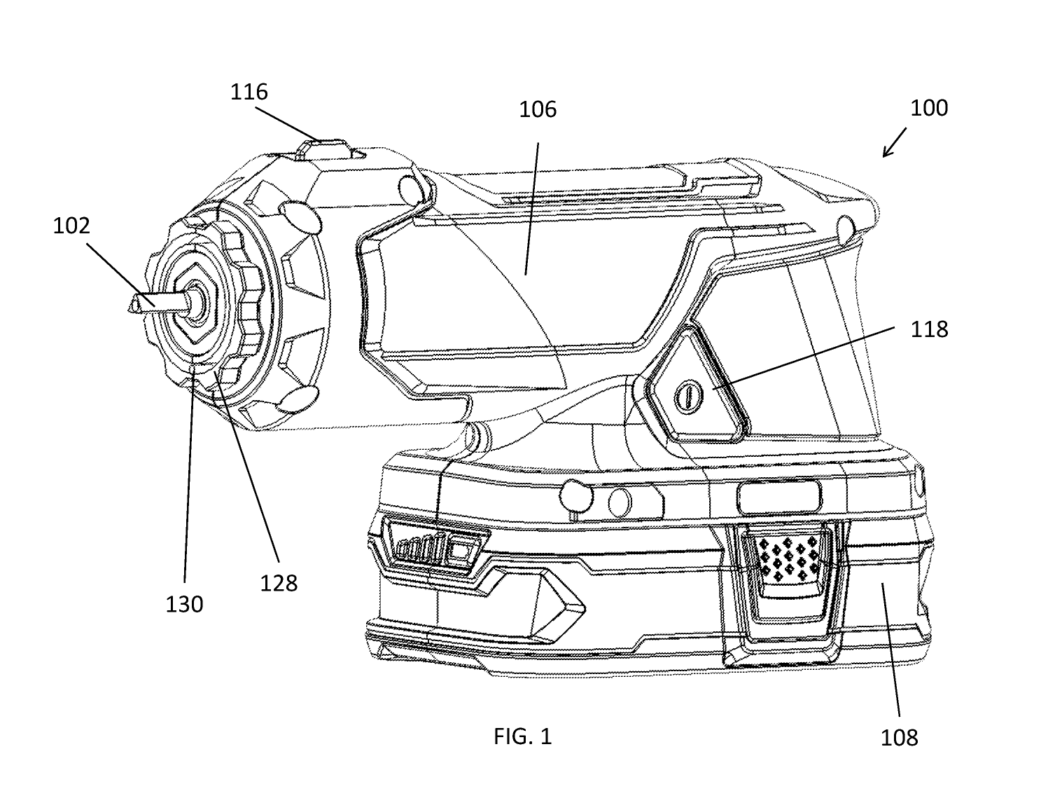

With reference to FIGS. 1 to 3, there is provided an embodiment of an electric tool 100 for facilitating starting of an engine, comprising a tool bit 102 having a bit portion 102A arranged to engage with a rotatable component of a starter module of the engine, and a transmission mechanism 112 arranged to transfer a rotational movement provided by a motor 104 housed within a casing of the electric tool 100 to the bit portion 102A, wherein the motor 104 is arranged to be powered by a power source connected thereto, and wherein the rotational movement provided by the motor 104 is transferred to the rotatable component of the starter module via the transmission mechanism 112 only if the bit portion 102A is engaged with the rotatable component.

In this embodiment, the electric tool 100 comprises generally three main components, including the main body 106, a removable tool bit 102 and a removable battery assembly 108. The removable battery assembly 108 is arranged to power the motor 104 in the main body 106. The battery assembly 108 may be a rechargeable battery including one or more rechargeable battery cell. Alternatively, the electric tool 100 may be powered by a non-rechargeable battery or an electric cable receiving electric power from an electric socket connected thereto.

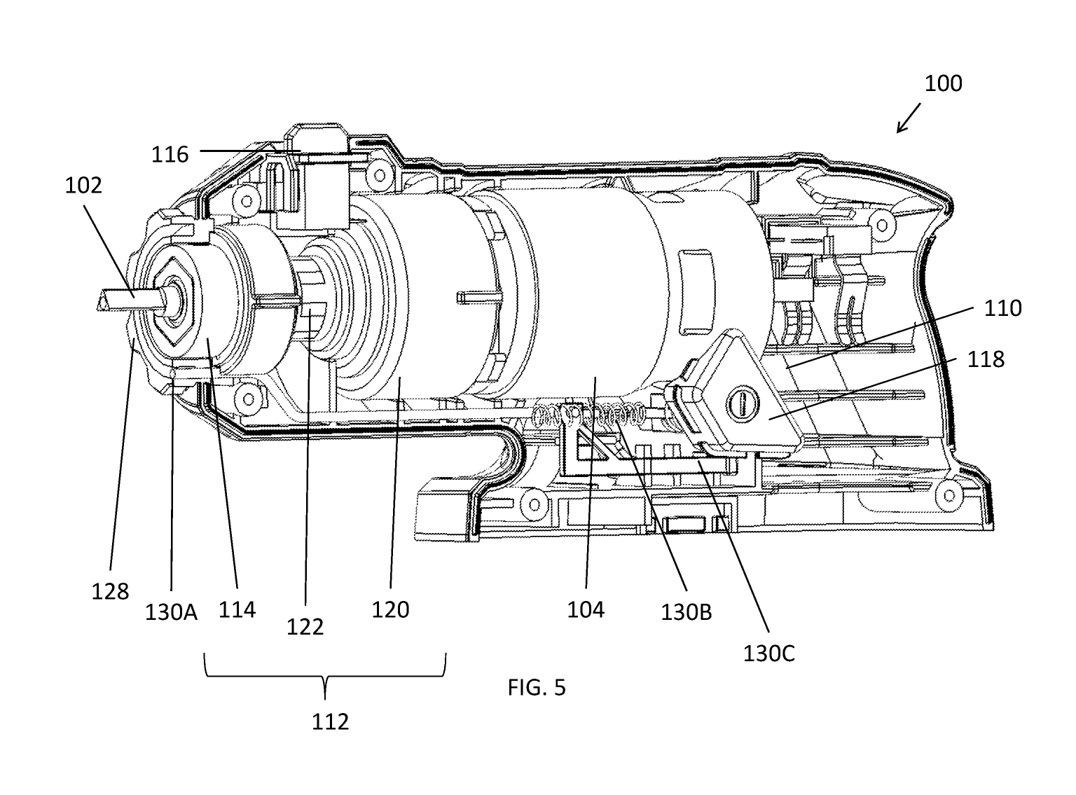

The main body 106 comprises a casing 110 for accommodating various internal components such as switches, motor 104, electrical connectors and a transmission mechanism 112 (as shown in FIG. 5). These components may be fixed by the mounting structures defined in the internal cavity. Preferably, the casing 110 may be made of a material such as plastic or any suitable material with certain mechanical strength such that the housed components are also effectively protected by the casing 110. The casing 110 may also define a cavity arranged to receive at least a portion of the battery assembly 108. In addition, the casing 110 may also include structures that facilitate gripping of the electric tool 100.

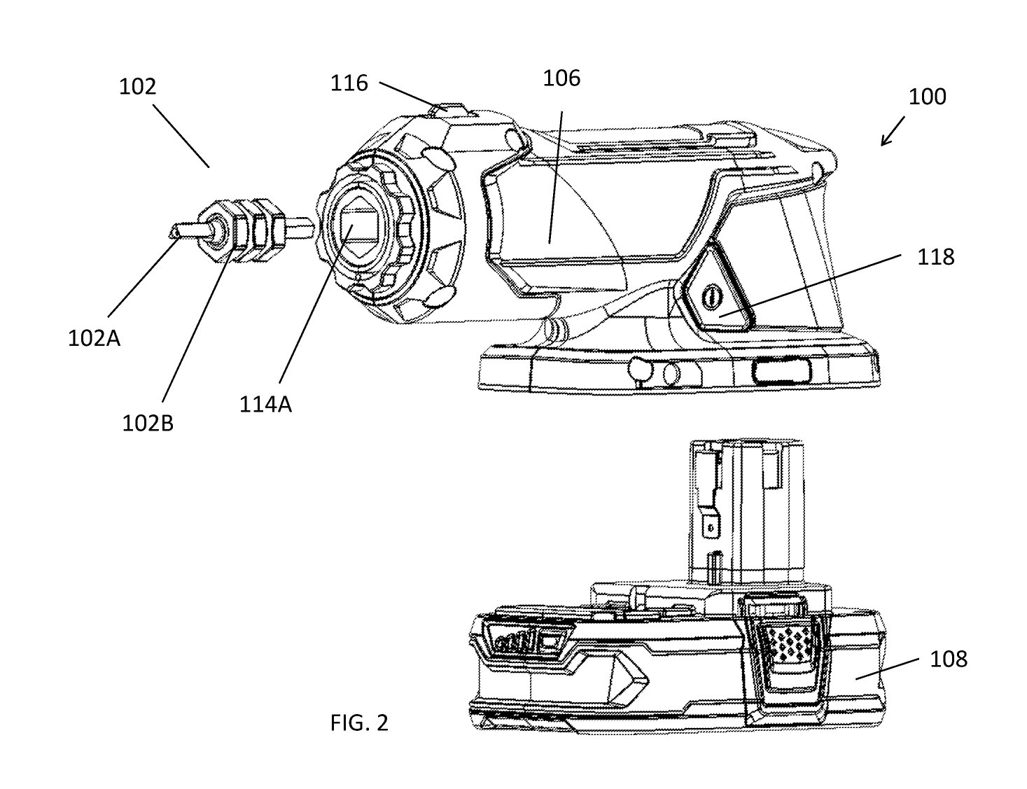

Referring to FIG. 2, the tool bit 102 is arranged to removably engage with the main body 106, and preferably with the transmission mechanism 112 of the main body 106. When the tool bit 102 is engaged with the transmission mechanism 112, preferably a chuck 114 of the transmission mechanism 112 provided on the main body 106, the tool bit 102 may be driven by a rotational movement provided by the motor 104 connected to the transmission mechanism 112. The tool bit 102 may also be selectively removed from the chuck 114 such that a different tool bit 102 may be inserted to the chuck 114, or the same tool bit 102 with a different bit ends may be inserted to the chuck 114 in a reversed orientation.

Preferably, the tool bit 102 may include a bit portion 102A provided at an end of the tool bit 102 and an engagement portion 102B. The bit portion 102A is defined with a predetermined shape and dimension such that it may be adapted to engage with an external component such as a rotatable component provided on a starter module of an engine (such as a gasoline engine, a petrol engine and/or a combustion engine), which is provided with a structure having a matching shape and dimension with the bit portion 102A. Besides, the engagement portion 102B is defined with a shape and dimension which matches with the chuck 114, i.e. the dimension of an exterior of the engagement portion 102B of the tool bit 102 substantially matches with the dimension of an interior of the receiving portion 114A of the chuck 114. The receiving portion 114A may receive the entire engagement portion 102B or a portion of the engagement portion 102B of the tool bit 102.

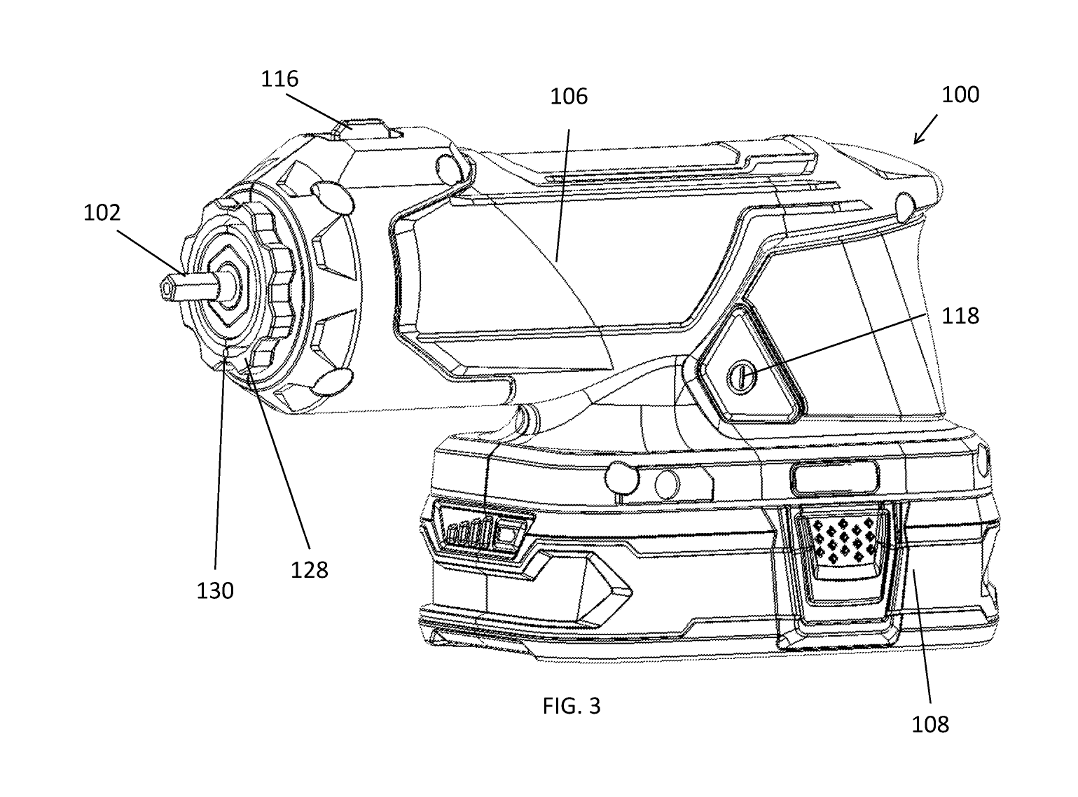

In the example embodiment as shown in FIGS. 1 and 2, the bit portion 102A of the tool bit 102 is defined with a shape such as a triangular shape which may be inserted to a hole or structure with a matching triangular shape and dimension. The engagement portion 102B is defined in a substantially larger hexagonal cross-sectional shape (the cross section is substantially perpendicular to a main axis of the tool bit 102 at an exterior of the engagement portion 102B) which is adapted for engaging with the same hexagonal hole 114A provided on the chuck 114. In an alternative embodiment as shown in FIG. 3, the bit portion 102A is defined with a pentagonal shape which may be inserted to a hole or structure with a matching pentagonal shape and dimension. It is appreciated by a skilled person that the bit portion 102A and the engagement portion 102B may be defined in different shapes according to different design. In addition, the shapes and/or the dimension of the bit portion 102A and the engagement portion 102B may be the same.

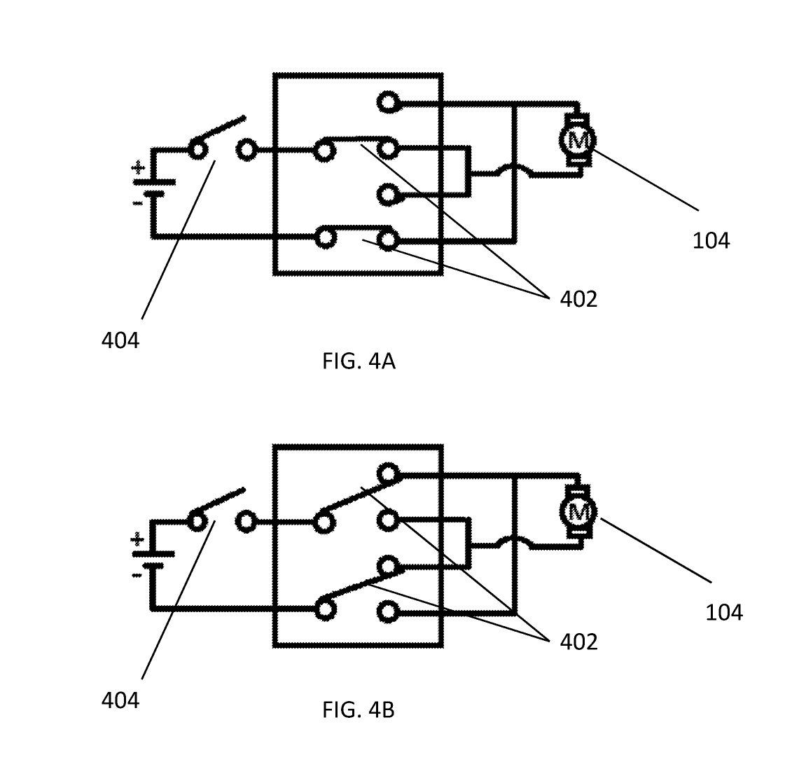

With reference to FIGS. 4A, 4B and 5, the electric tool 100 may further comprise a direction switching mechanism arranged to select a direction of the rotational movement provided by the motor 104. The electrical connection may be similarly implemented according to the schematic diagram of FIGS. 4A and 4B. The main body 106 may be provided with a direction selector 116 which selectively close the switches 402 in two different circuits to select the desire path of current flow, such that the current flows into the motor 104 in the selected one of the two different directions when the main switch 404 is close in response to an actuation of a press button 118 provided on the main body 106.

Preferably, the direction selector 116 may be an actuator arranged to select the direction of the rotational movement provided by the motor 104, and the actuator 116 is arranged to be manipulated by a user of the electric tool 100. Such configuration enables the user to select the operation direction of the rotational movement provided by the motor 104. Hence the electric tool 100 being used for starting engines with different rotation directions in of the rotatable component in a starter module. Alternatively, the direction may be automatically selected by the electric tool 100 which may be discussed later in the disclosure.

With reference to FIGS. 5 to 8, in this embodiment, the tool bit 102 may be driven by the motor 104 via the transmission mechanism 112 provided in the main body 106. The transmission mechanism 112 generally includes the abovementioned chuck 114 arranged to engage with the tool bit 102, and the chuck 114 is further couples to a transmission 120 arranged to convert the rotational output of the motor shaft to a rotational movement with a desired rotational speed and torque. For example, the transmission 120 may reduce the speed and increase the torque which is more suitable for facilitating starting of an engine. Alternatively, the electric tool 100 may comprise a different transmission or may not comprise a transmission such that the chuck 114 may be connected to output shaft of the motor 104 directly, in accordance with different designs.

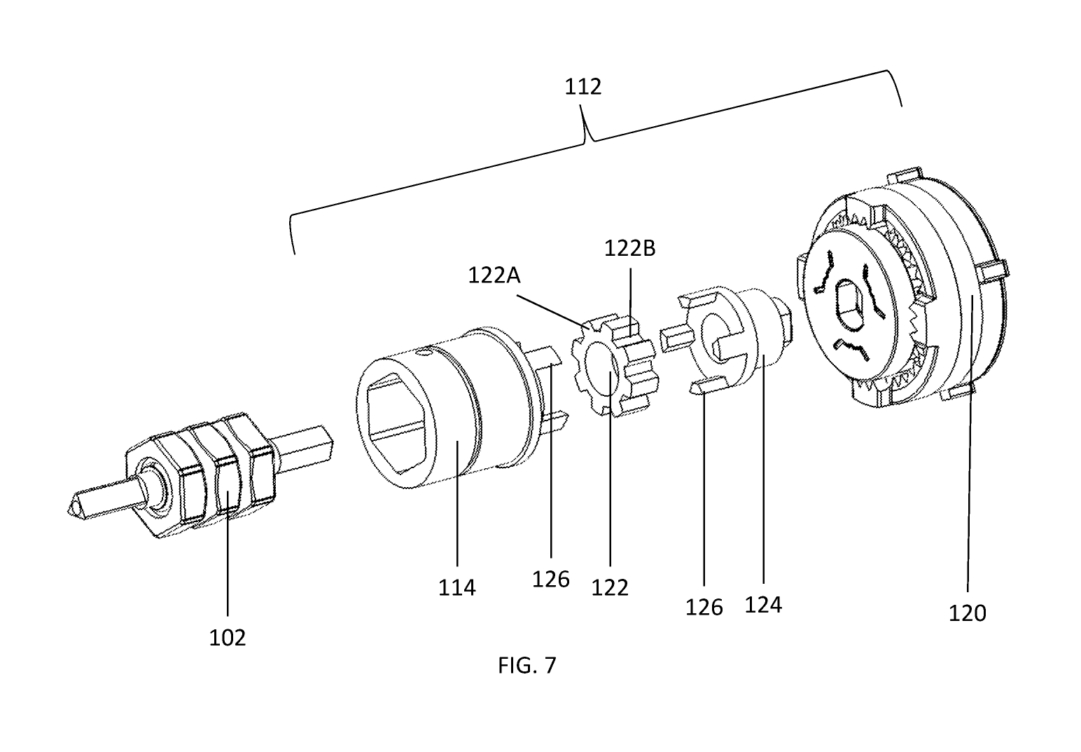

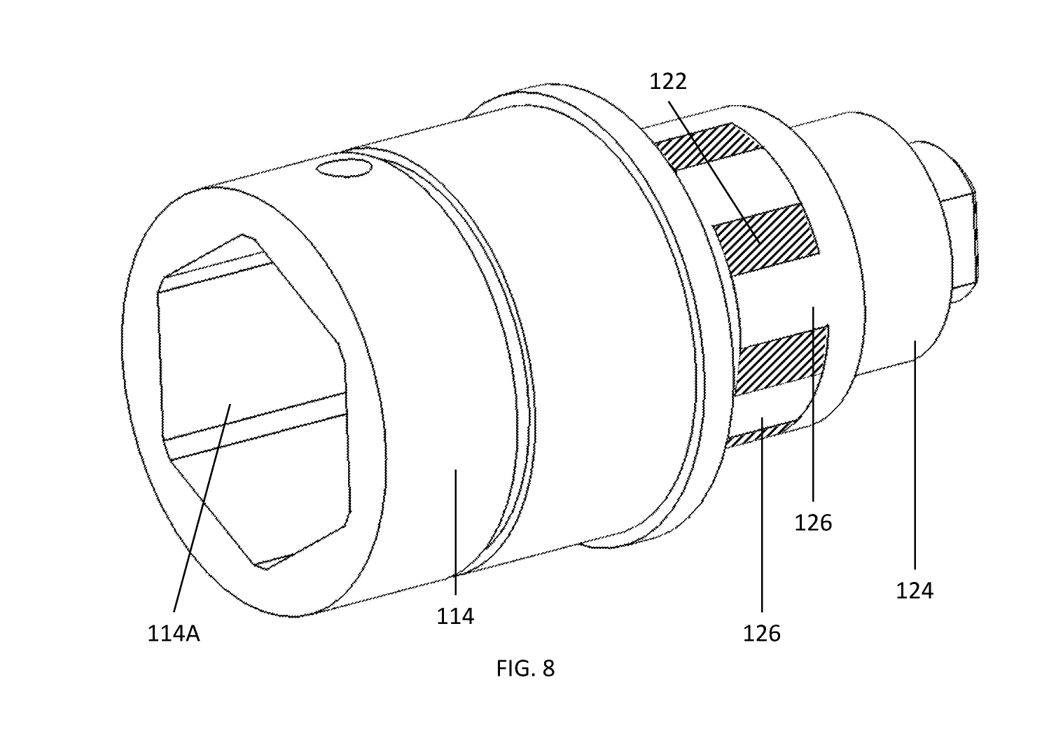

Preferably, the transmission mechanism 112 further comprises a resilient member 122, wherein the chuck 114 is arranged to engage with a transmission 120 or an output shaft of the motor 104 via the resilient member 122. Referring to FIGS. 7 and 8 (the shaded component is the resilient member 122), the resilient member 122 in this embodiment is a rubber ring having a plurality of protrusion 122A defining a plurality of slots 122B arrange to engage with the chuck 114 and the transmission connector 124. The engagement structures 126 on the chuck 114 and the transmission connector 124 are alternatively placed in these slots 122B on the resilient member 122, such that rotational movement provided at the output of the transmission may be transferred to the chuck 114 via the resilient member 122.

Advantageously, as the resilient member 122 may be made of rubber or any other resilient material with shock absorbing properties, the resilient member 122 may absorb an impact induced on a driven component and/or the motor 104 during an operation of the electric tool 100. These driven components include the transmission 120, the chuck 114, the tool bit 102 and/or the rotatable component of the starter module of the engine coupled to the electric tool 100.

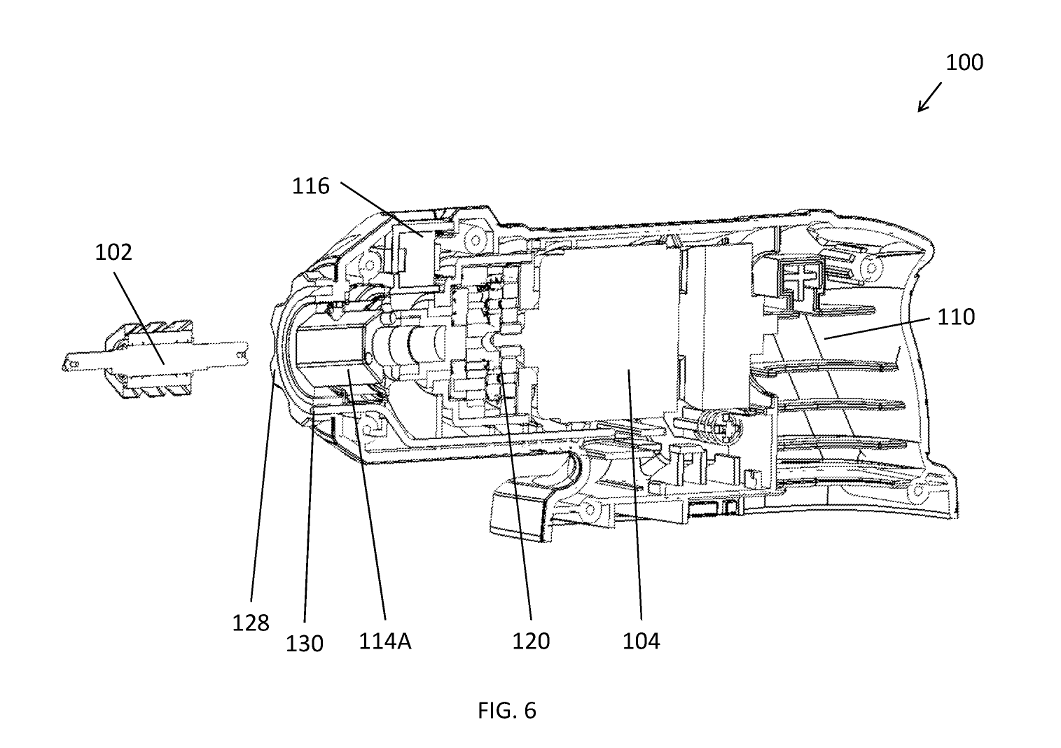

The electric tool 100 may be further provided with a locking structure 128 on the casing 110 arranged to cooperate with a corresponding locking structure provided on the starter module. Referring to FIGS. 5 and 6, locking structures such as the teeth-like structure 128 may be provided at a position substantially near the chuck 114 such that when the bit portion 102A of the tool bit 102 is substantially engaged with the starter module, the locking structure 128 may mate with the corresponding teeth-like structure provided on the starter module. Effectively, the cooperation of the locking structure 128 on the casing 110 and the corresponding locking structure on the starter module may prevent a relative rotational movement of the casing 110 with respect to the starter module. This may enhance the stability and efficiency of starting an engine with the electric tool 100 as the user is not required to overcome the induced reversed rotational movement on the main body 106 curing operation.

Optionally or additionally, the electric tool 100 may further comprise an interlock structure 130 arranged to enable the activation of the motor 104. Referring to FIGS. 5 and 6, the interlock structure 130 includes an interlock actuator 130A protruding out from the casing 110 at a position proximate to the abovementioned locking structure 128. The interlock structure 130 may be provided with a spring 130B to reset the interlock actuator 130A when it is not actuated. When the locking structure 128 on the casing 110 and the corresponding locking structure are securely engaged, the interlock actuator 130A may then be actuated by a matching structure (such as a protruding ring which matches with the ring-shaped groove provided proximate to the locking structure 128 on the casing 110).

The interlock actuator 130A is further connected to a structure 130C arranged to allow/disallow the main switch 404 housed in the casing 110 being actuated by the press-button 118 provided on the casing 110. For example, a blocking structure 130C may be used to block the press-button 118 from being accessing the main switch 404 if the interlock actuator 130A is not actuated, or a lever may be used to actuate the main switch 404 when the lever is moved to a predetermined position near the press-button 118 when the interlock actuator 130A is actuated and when the lever is pushed by the main button 118. This interlock further ensures that then electric tool 100 may only be activated when the locking structures on both sides are securely engaged and the electric tool 100 and the starter module are engaged in proper relative positions to prevent any accident or damages to the electric tool 100 and/or the starter module.

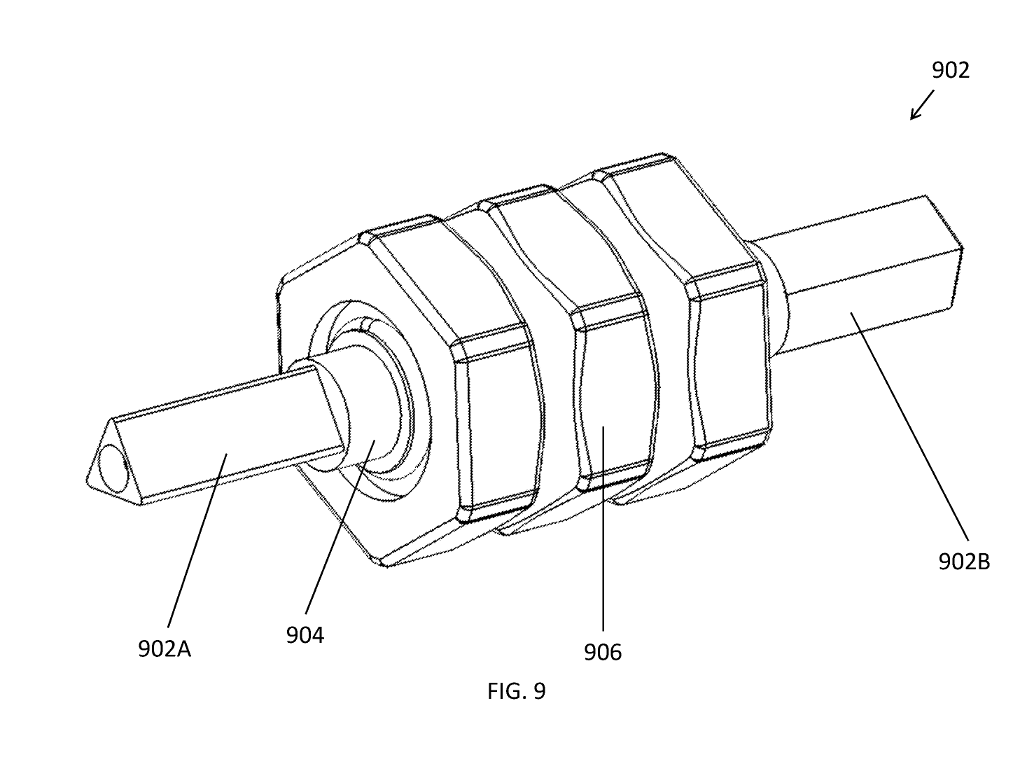

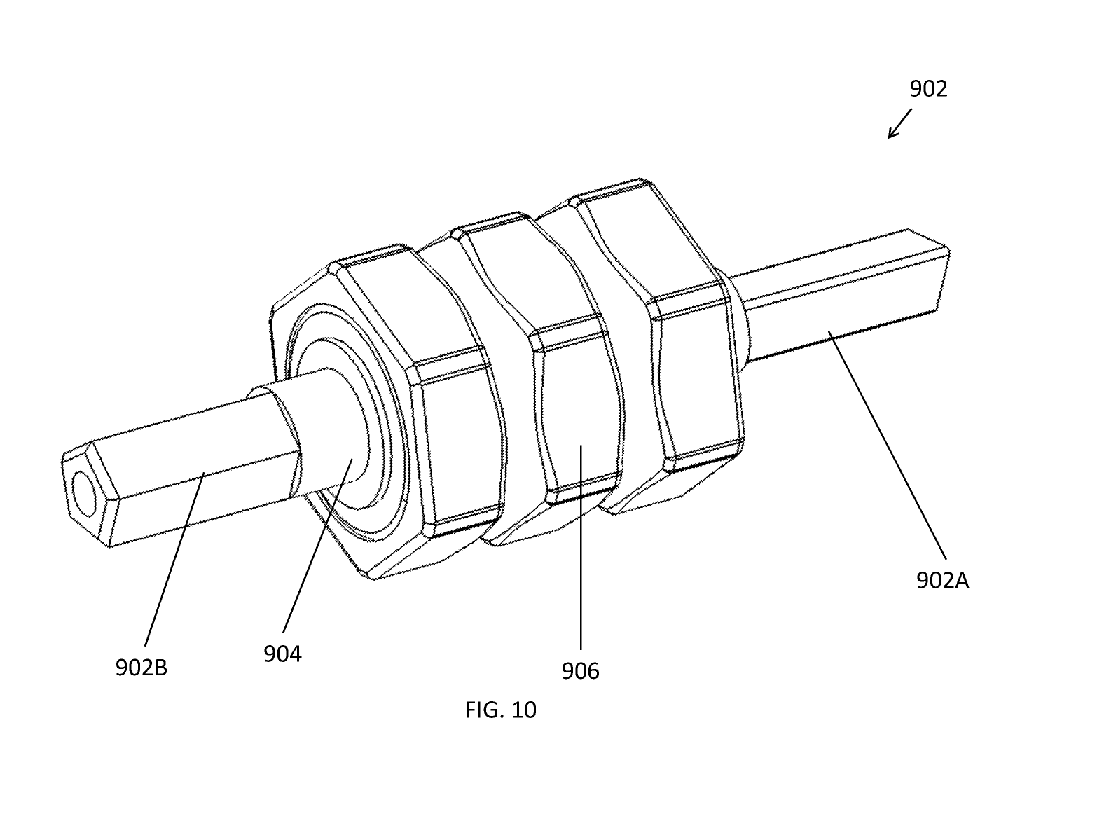

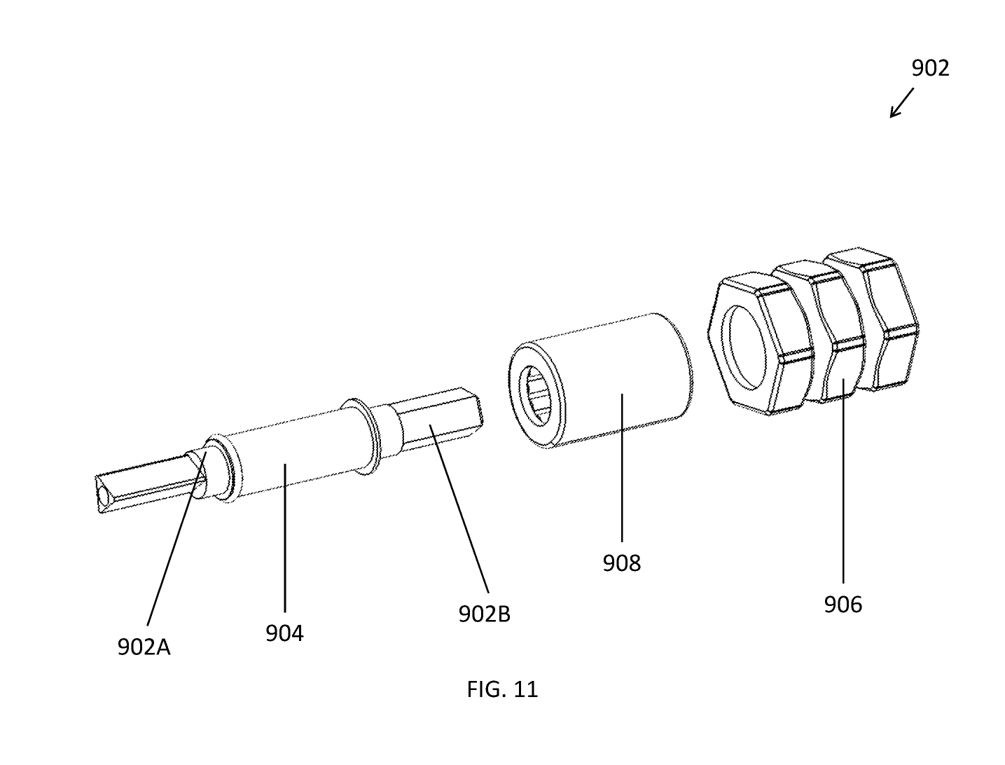

With reference to FIGS. 9-11, there is shown an embodiment of a tool bit 902 for use in a power tool, comprising a central shaft 904 arranged to selectively engage with an outer ring 906, such that the outer ring 906 is arranged to allow the central shaft 904 to rotate in a first direction along a common axis of the central shaft 904 and the outer ring 906 with respect to the outer ring 906, and is further arranged to prevent the central shaft 904 to rotate in a second direction opposite to the first direction along a common axis of the central shaft 904 and the outer ring 906 with respect to the outer ring 906.

In this embodiment, the central shaft 904 is provided with a triangular bit portion 902A at an end of the central shaft 904. The central shaft 904 is connected to the outer ring 906 through a one-way engagement/transmission mechanism 908 (such as a one-way bearing), so as to permit the central shaft 904 to rotate freely in a first direction relative to the outer ring 906 along a common central axis. In other words, the central shaft 904 is prevented from rotating in a second direction opposite to the first direction relative to the outer ring 906 or the central shaft 904 is engaged to the outer ring 906 when attempted to rotate in a second direction relative to the outer ring 906. In one example embodiment, the one-way bearing 908 is fixed to the outer ring 906.

Preferably, when the tool bit 902 is used in the electric tool 100, the outer ring 906 may define the engagement portion 102B such that the outer ring 906 may receive rotational movement provided by the motor 104 via the transmission mechanism 112. The tool bit 902 may be configured to allow the central shaft 904 to rotate freely in a first direction with respect to the outer ring 906. As a result, during operating, the bit portion 902A formed at an end of the central shaft 904 selectively engages with the one-way engagement mechanism 908 when the outer ring 906 receive a rotational movement in a first direction, and such rotational movement may then be further transferred to the bit portion 902A of the central shaft 904 via the one-way bearing 908. In other words, when the outer ring 906 receives a rotational movement in a second direction, such the central shaft 904 rotate freely with respect to the outer ring 906 due to the disengagement between the central shaft 904 and the outer ring 906. Therefore, such rotational movement received by the outer ring 906 is not transferred to the bit portion 902A of the central shaft 904.

In addition, the one-way engagement mechanism 908 may further prevent a rotational movement provided by the rotatable component of the starter module of the engine from being transferred to the motor 104 via the transmission mechanism 112 and the tool bit 102/902. During operating, when a engine is started, the crankshaft will rotates in a relatively faster rotation speed relative to the tool bit 102/902 driven by the motor 104, the central shaft 904 will subsequently disengage with the outer ring 906 due to the faster rotation speed of the central shaft 904. Effectively, this prevents the torque being transferred to the electric tool 100 and hence protects the electric tool 100 from being damaged by the reversed torque.

In a preferred embodiment, the tool bit 902 is provided with a second bit portion 902B on a second end of the central shaft 904/tool bit 902. The second bit portion 902B may be defined with a different shape and/or dimension when compared to the one 902A provided at the opposite end, such as a pentagonal shape for use in starting a starter module provided with a rotatable component having a corresponding pentagonal hole or receiving structure. Thus the same tool bit 102/902 may be used for starting an engine with a starter module having a triangular receiving hole on the rotatable component or a starter module having a pentagonal receiving hole on the rotatable component.

This may also ensure that engines with different starter modules may only be started by an electric tool 100 mounted with a suitable tool bit 102/902 in a proper position/orientation, i.e. the starter module having a triangular receiving hole prevents an engagement with the second bit portion 902B in a pentagonal shape. Such configuration may provide further advantageous that, when the tool bit 102/902 is implemented with the one-way engagement mechanism, the two bit portions are restricted to selectively engage with the outer ring 906 in opposite directions. Therefore, a first starter module configured to start an engine when receiving a rotational movement in a first direction may be provided with a triangular receiving hole on the rotatable component, and the electric tool 100 mounted with the triangular bit portion 902A extending out from the main body 106 with the first direction of the rotation of the motor 104 selected, in addition to the interlock actuator 130A being actuated due to the secure engagement of the locking structures 128, may be used to start the engine with the first starter module.

Failure in fulfilling any of the above condition prevents the starting of the engine. For example, a reversed direction of the motor is selected causes an disengagement of the central shaft to the outer ring, a pentagonal bit portion does not match with the triangular receiving hole on the starter module thus the engagement fails, a loosen engagement between the electric tool and the starter module prevents the electric tool from activating due to the interlock mechanism.

Similarly, a second starter module configured to start an engine when receiving a rotational movement in a second direction may be provided with a pentagonal receiving hole on the rotatable component, and the electric tool 100 mounted with the pentagonal bit portion 902B extending out from the main body 106 with the second direction of the rotation of the motor 104 selected, in addition to the interlock actuator 130A being actuated due to the secure engagement of the locking structures 128, may be used to start the engine with the second starter module.

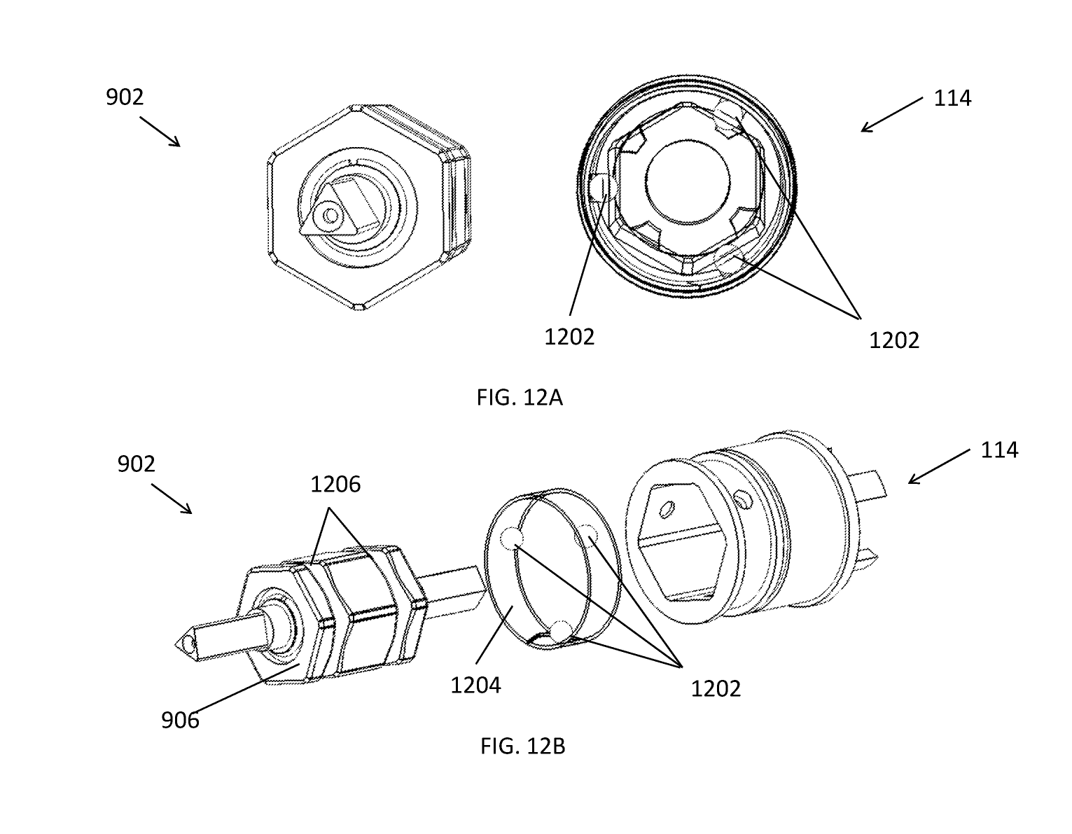

With reference to FIGS. 12A and 12B, the tool bit 902 may be mounted to the chuck 114 with one or more supplementary engagement arrangements. For example, three snap balls 1202 may be provided in the chuck 114 around the hexagonal interface, such that a portion of each of the snap balls 1202 protrudes towards the central axis of the chuck 114 from the interior surface of the hexagonal interface of the chuck 114. The snap balls 1202 may be bias and held by a resilient member such as a spring plate 1204 fixed around the snap balls 1202 and the chuck 114. When the tool bit 902 is inserted to the chuck 114, the snap balls 1202 engages with a corresponding one of the two groves 1206 provided on the outer ring 906 of tool bit 902 to secure the position of the tool bit 902 in the chuck 114. Optionally, additional snap balls 1202 or additional combinations of snap balls 1202 and resilient member 1204 may be included to enhance the engagement between the tool bit 902 and the chuck 114.

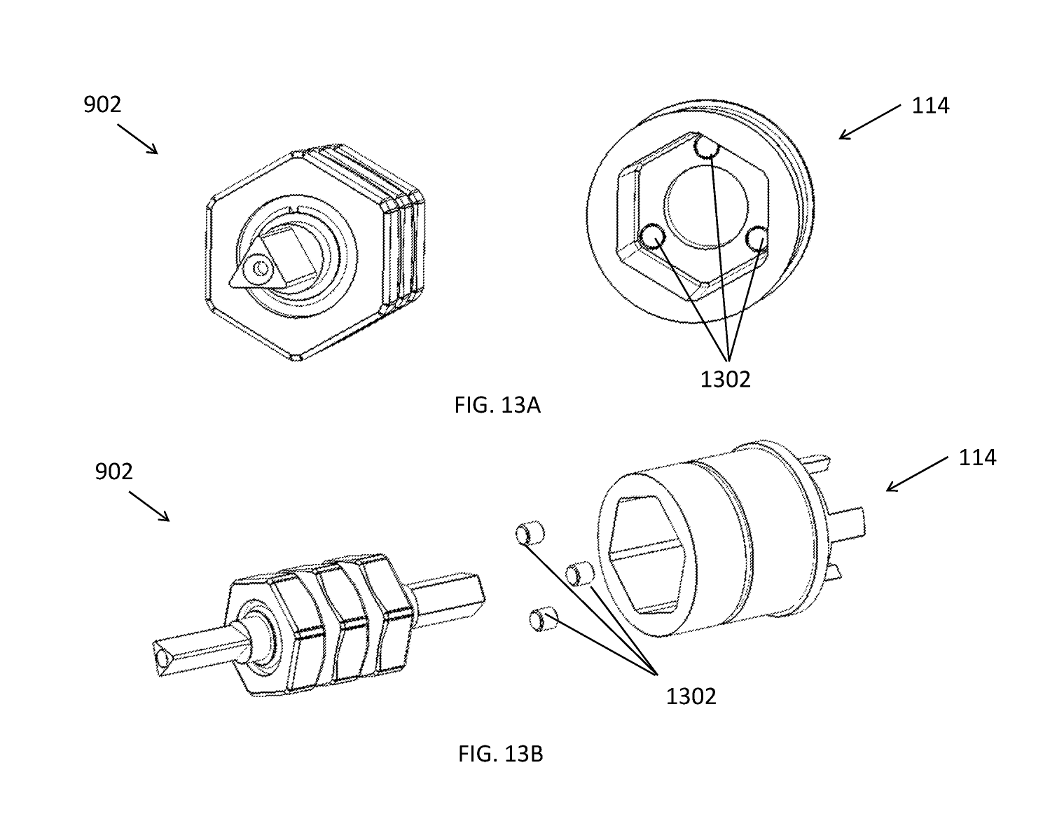

In an alternative embodiment as shown in FIGS. 13A and 13B, the supplementary engagement arrangement includes one or more magnetic member. Three magnets 1302 may be fixed to a base of the chuck 114 such that the tool bit 1202 may be magnetically secured by the magnets when it is inserted into the chuck 114. Optionally, different number of magnetic members may be used, or the engagement between the tool bit 902 and the chuck 114 may be further enhanced by incorporating two or more supplementary engagement arrangements of FIGS. 12A and 13A to in a chuck 114.

These embodiments may be advantageous in that, the electric tool may be used for facilitating starting an engine with a starter module, and the user are only allowed to start the engine when certain requirements are properly fulfilled, namely the secure engagement between the electric tools and the starter module, the proper bit (portion) being used and the desired direction of the rotational of the motor being selected. These requirements protect the electric tool and/or the engine from being damaged and the user getting hurt due to incorrect operations.

In addition, the user may not necessary worry about damaging the engine if a wrong direction is selected, since the one-way engagement mechanism only transfer rotational movement to the starter module in the only correct direction. Hence if a user may observe that the bit portion of the tool bit is not driven by the rotating chuck, he may simply select the other available direction and continue to start the engine using the electric tool.

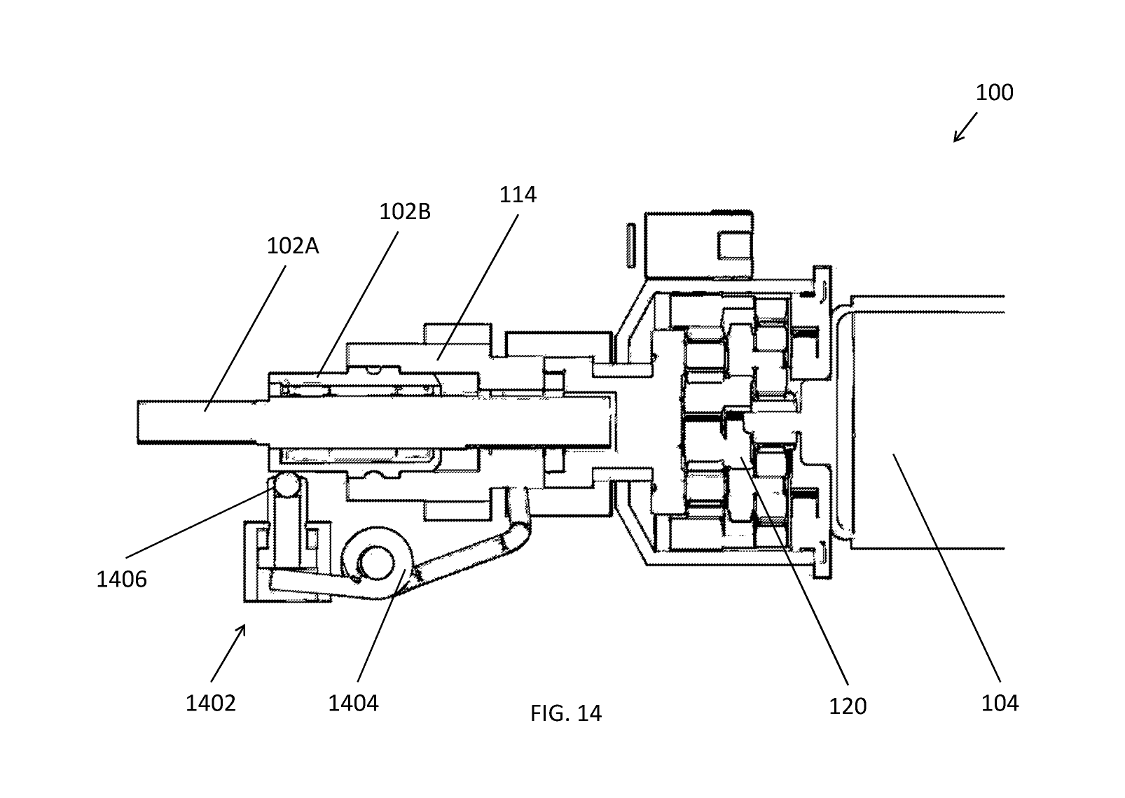

In an alternative embodiment, the direction switching mechanism includes a detection mechanism 1402 arranged to detect an engagement of the tool bit 102 to the transmission mechanism 112. With reference to FIG. 14, the detection mechanism 1402 may include a spring arm 1404 extending from the main body 106 arrange to detect the engagement of the tool bit 102 to the chuck 114 or the transmission mechanism 112. A portion 906B of the outer ring 906 pushes the spring arm 1404 indicating that the tool bit 102 is inserted to the chuck 114 in a first orientation (such as with the triangular bit portion 902A extending out). Accordingly, the direction switching mechanism selects the direction of the rotational movement provided by the motor 104 in accordance with a predetermined direction (such as the first direction as previous discussed). The direction switching mechanism may be implemented with an actuator being actuated by the spring arm, or the switching mechanism may be implemented with electronic components.

When the tool bit 102/902 is inserted to the chuck 114 in an opposite orientation, a smaller portion or none of the engagement portion 102B may protrude from the chuck 114, such that the spring arm 1404 is not pushed similarly as the previous example. Accordingly, the direction switching mechanism selects an opposite direction of the rotational movement provided by the motor 104.

Optionally, the end of the spring arm 128 in contact with the tool bit 102/902 may be provided with a roller or a ball 1406 to prevent rubbing between the end of the spring arm 128 and the tool bit 102.

These embodiments may also be implemented to different tools as appreciated by a person skilled in the art, including but not limited to an electric driver and/or a power drill.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1-40. (canceled)

41. A power tool operable to facilitate starting of an engine, the engine including a starter module having a rotatable component, the power tool comprising:
a housing;
a motor coupled to the housing, the motor configured to be powered by a power source;
a transmission mechanism coupled to the housing, the transmission mechanism driven by the motor about a rotational axis, the transmission mechanism configured to receive a tool bit sized to engage the rotatable component of the starter module; and
an actuator coupled to the housing, the actuator configured to detect the starter module, the actuator operable to enable actuation of the motor to drive the transmission mechanism in response to detection of the starter module.

42. The power tool of claim 41, further comprising a trigger operable to supply power to the motor from the power source upon actuation of the trigger, wherein the actuator is in communication with the trigger to selectively block the trigger from being actuated in response to the actuator not detecting the starter module.

43. The power tool of claim 42, wherein the actuator includes a linkage and a biasing member, and wherein the biasing member biases an end of the linkage out of the housing, and wherein the linkage is configured to be pushed into the housing to enable actuation of the trigger in response to the power tool engaging the starter module.

44. The power tool of claim 41, wherein the housing includes a locking structure configured to engage with a corresponding locking structure of the starter module to inhibit rotation of the housing relative to the starter module.

45. The power tool of claim 44, wherein the actuator enables actuation of the motor when the locking structure of the housing engages the corresponding locking structure of the starter module.

46. The power tool of claim 41, further comprising a direction switching mechanism operable to select a first rotational direction of the motor in response to engagement of the tool bit and the transmission mechanism in a first orientation, wherein the direction switching mechanism is operable to select a second rotational direction of the motor in response to engagement of the tool bit and the transmission mechanism in a second orientation.

47. The power tool of claim 41, wherein the tool bit includes a sleeve engageable with the transmission mechanism and a shaft coupled to the sleeve, and wherein the coupling between the shaft and the sleeve allows rotational movement of the shaft relative to the sleeve in a first direction and inhibits rotational movement of the shaft relative to the sleeve in a second direction opposite the first direction.

48. The power tool of claim 47, wherein the sleeve is coupled to the shaft by a one-way bearing.

49. The power tool of claim 47, wherein the tool bit includes a first bit portion and a second bit portion with the sleeve positioned between the first and second bit portions, and wherein the first bit portion is configured to engage the rotatable component of the starter module, and wherein the second bit portion is configured to engage a rotatable component of a different starter module.

50. A power tool operable to facilitate starting of an engine, the engine including a starter module having a rotatable component, the power tool comprising:
a housing;
a motor coupled to the housing, the motor configured to be powered by a power source;
a transmission mechanism coupled to the housing, the transmission mechanism driven by the motor about a rotational axis;
a tool bit including a sleeve engageable with the transmission mechanism and a shaft coupled to the sleeve, the coupling between the shaft and the sleeve allows rotational movement of the shaft relative to the sleeve in a first direction and inhibits rotational movement of the shaft relative to the sleeve in a second direction opposite the first direction, the shaft includes a bit portion configured to engage the rotatable component of the starter module; and
an actuator coupled to the housing, the actuator configured to detect the starter module, the actuator operable to enable actuation of the motor to drive the transmission mechanism in response to detection of the starter module.

51. The power tool of claim 50, further comprising a trigger operable to supply power to the motor from the power source upon actuation of the trigger, wherein the actuator is in communication with the trigger to selectively block the trigger from being actuated in response to the actuator not detecting the starter module.

52. The power tool of claim 51, wherein the actuator includes a linkage and a biasing member, and wherein the biasing member biases an end of the linkage out of the housing, and wherein the linkage is configured to be pushed into the housing to enable actuation of the trigger in response to the power tool engaging the starter module.

53. The power tool of claim 50, wherein the housing includes a locking structure configured to engage with a corresponding locking structure of the starter module to inhibit rotation of the housing relative to the starter module.

54. The power tool of claim 53, wherein the actuator enables actuation of the motor when the locking structure of the housing engages the corresponding locking structure of the start module.

55. The power tool of claim 50, further comprising a direction switching mechanism operable to select a first rotational direction of the motor in response to engagement of the tool bit and the transmission mechanism in a first orientation, wherein the direction switching mechanism is operable to select a second rotational direction of the motor in response to engagement of the tool bit and the transmission mechanism in a second orientation.

56. The power tool of claim 50, wherein the sleeve is coupled to the shaft by a one-way bearing.

57. The power tool of claim 50, wherein the bit portion is a first bit portion, and wherein the tool bit includes a second bit portion with the sleeve positioned between the first and second bit portions, and wherein the second bit portion is configured to engage a rotatable component of a different starter module.

58. A tool bit selectively coupled to a power tool, the tool bit comprising:
a sleeve configured to engage with a transmission mechanism of the power tool; and
a shaft coupled to the sleeve, the coupling between the shaft and the sleeve allows rotational movement of the shaft relative to the sleeve in a first direction and inhibits movement of the shaft relative to the sleeve in a second direction opposite the first direction.

59. The tool bit of claim 58, wherein the shaft includes a first bit portion and a second bit portion with the sleeve positioned between the first and second bit portions, and wherein the first and second bit portions are each configured to engage a rotatable component of different starter modules operable to facilitate starting of an engine.

60. The tool bit of claim 58, wherein the sleeve is coupled to the shaft by a one-way bearing.
